(19) United States
(12) Patent Application Publication
(10) Pub. No.: US 2022/0279244 A1
(43) Pub. Date: Sep. 1, 2022

(54) BLURRED VIEWER MONITORING AND ADVERTISEMENT SYSTEM

(71) Applicant: Charter Communications Operating, LLC, St. Louis, MO (US)

(72) Inventor: Michael Bender, Rye Brook, NY (US)

(21) Appl. No.: 17/188,382

(22) Filed: Mar. 1, 2021

(51) Int. Cl. H04N 21/442; H04N 21/81; H04N 21/45; H04N 21/2668

(52) U.S. Cl. CPC H04N 21/44218; H04N 21/812; H04N 21/4532; H04N 21/2668

(57) ABSTRACT

An image processing system receives blurred images of a viewer viewing a display screen. At least a portion of the images are blurred to protect privacy of the viewer. The image processing system monitors motion of the viewer in the blurred images. Based on the monitored motion, the image processing system stores data indicating a reaction of the at least one viewer viewing content displayed on the display screen. For example, if the image processing system detects that motion in the blurred image is a person no longer viewing a display screen, the image processing system stores data indicating that the person is not interested in the content. Conversely, if the image processing system detects that the blurred image is a person who watches the content in its entirety, the image processing system assumes that the person is interested in the content.

### BACKGROUND

One source of revenue for commercial television broadcasters is the sale of broadcast time to advertisers. For example, as is well known, most television programs include windows of time in which a commercial broadcaster inserts advertisements for viewing by a respective viewers tuned to a particular channel.

In certain cases, advertisers attempt to target specific advertisements to viewer segments that are likely to be most receptive to the message captured by the advertisement. One way to target advertisements to viewers includes identifying what types of viewers are associated with specific television programs. For example, the commercial broadcaster may assume that viewers watching a fishing program are more likely to response favorably to advertisements directed to sale of fishing equipment or a boat. Accordingly, the subject of the video stream broadcasted may dictate to some extent what advertisements should be inserted in the available time slots.

Another way of targeting specific viewing audiences includes selecting advertisements based on a geographical region in which the video stream and corresponding advertisements are broadcasted. The assumption is that viewers in one local or regional area are more likely to be receptive to an advertisement's message than viewers in a different area. Unfortunately, such a technique does not account for an individual viewer's likes or dislikes of a respective type of advertisement. Hence, the advertisement may not be particularly effective.

Thus, multiple techniques can be implemented to determine what advertisements are best to deliver in different circumstances.

### BRIEF DESCRIPTION OF EMBODIMENTS

Embodiments herein provide novel ways of providing improved wireless communications to one or more mobile communication devices in a network environment.

More specifically, a network environment includes an image processing system such as image analyzer hardware and corresponding executed software. The image analyzer receives blurred images of one or more viewers viewing a display screen. At least a portion of the images are blurred to protect privacy of the one or more viewer. In one embodiment, the image analyzer monitors an amount of motion of a respective viewer in the blurred images. Based on the monitored motion, the image analyzer stores viewer data indicating a reaction of the respective viewer viewing content displayed on the display screen. In one embodiment, the viewer data indicates a degree to which each of the one or more viewers likes or dislikes different content played back on the display screen at different times.

In accordance with more specific example embodiments, if the image processing system detects that motion in blurred images being monitored represents a respective person no longer viewing a display screen during playback of the content, the image processing system stores data indicating that the respective person (in the blurred image) is not interested in the content being played back. Conversely, if the image processing system detects that the blurred image is a person who watches the content in its entirety due to lack of motion of the respective viewer, the image processing system assumes or considers that the respective person is interested in the content.

In a similar manner, the image processing system determines whether each of multiple viewers is interested in the content being played back.

Further embodiments herein include, via the image processing system, determining a type of motion (such as ingress, egress, etc.) of the respective viewer based on identification of a size of a display region representing movement of the first viewer in multiple different timeframes of the blurred images.

In further example embodiments, the content on the display screen viewed by the one or more viewers is an advertisement displayed on the display screen. A monitoring device (such as a video monitoring camera) produces video images (such as multiple frames of images) of the one or more viewers watching the content played back on the display screen. As previously discussed, an image blurring application applies a blur function to the video images of the at least one viewer watching the advertisement on the display screen to protect identities of the viewers.

In one embodiment, the display screen resides in a subscriber domain. The image processing system is further operative to produce subscriber account information to include an identity of video equipment (such as a video monitoring camera) operated in the subscriber domain to indicate an identity of the display screen and/or content distribution system (such as set top box or other suitable equipment) in the subscriber domain. In further example embodiments, the blurred images of the subscriber domain are derived from video images of the one or more viewers in the subscriber domain viewing the display screen.

In still further example embodiments, the image blurring application monitoring the motion detects a change in color patterns in the blurred images to determine states of motion associated with the one or more viewers. In one embodiment, the change in color patterns in the blurred images indicates a first viewer of the at least one viewer no longer viewing the display screen.

In yet further example embodiments, monitoring motion of the at least one viewer in the blurred images includes: partitioning the blurred images into multiple regions and then identifying differences amongst the blurred images over time. The identified differences indicate motion of the one or more viewers watching the display screen.

In further example embodiments, the blurred images include a first blurred image of the at least one viewer viewing the display screen at a first instant in time and a second blurred image of the at least one viewer viewing the display screen at a second instant in time. The image analyzer partitions the first blurred image into first display regions and partitions the second blurred image into second display regions. The image analyzer then compares the first display regions to the second display regions in a grid of the blurred video images to identify the motion of one or more viewers in the subscriber domain.

Further embodiments herein include, as previously discussed, via the image analyzer hardware, storing viewer data indicating reactions of the respective viewers. The viewer data indicates the degree to which each of the one or more viewers likes or dislikes corresponding content currently displayed on the display screen. The image analyzer records attributes of the content displayed on the display screen at multiple different instants of time over a time duration. Via analysis of the blurred images of the at least one viewer viewing the display screen over the time duration, the image analyzer records corresponding motion associated with the content for each the multiple instants of time.

In still further example embodiments, the image analyzer analyzes ingress and egress patterns of the at least one viewer entering and exiting a zone (such as a viewing room in which the display screen is located) of the subscriber domain based on: i) an identity of the display screen, ii) a genre of the content displayed on the display screen, and iii) a time of the content being displayed on the display screen. In one embodiment, the image analyzer compares historical patterns for a viewer viewing the content on the display screen to other subscribers and to their personal historical viewing of the display screen.

In further example embodiments, via analysis of the blurred images and monitored motion, the image analyzer or other suitable entity determines a probability that a corresponding viewer of the display screen will discontinue viewing the display screen during display of a particular advertisement (i.e. content) on the display screen. In one embodiment, the image analyzer selects a subsequent advertisement to display on the display screen based on the stored data indicating the degree to which the at least one viewer liked or disliked the content previously displayed on the display screen.

Embodiments herein are useful over conventional techniques. For example, as previously discussed, blurring of images protects privacy of individuals yet enables more efficient delivery of advertisements.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (such as any computer readable hardware storage medium, computer readable storage hardware, etc.) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to provide efficient use of wireless resources in a network environment. The instructions, when executed by computer processor hardware, cause the computer processor hardware (such as one or more co-located or disparately processor devices or hardware) to: receive blurred images of at least one viewer viewing a display screen, the blurred images protecting privacy of the at least one viewer; monitor motion of the at least one viewer in the blurred images; and based on the monitored motion, store data indicating a reaction of the at least one viewer viewing content displayed on the display screen.

Note that the ordering of the steps above has been added for clarity sake. Further note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing communication services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating content distribution and analysis of blurred images of viewers viewing played back content according to embodiments herein.

FIG. 2 is an example diagram illustrating image processing and advertisement selection according to embodiments herein. FIG. 3 is an example diagram illustrating flow control associated with analyzing blurred images and providing appropriate advertisements to a subscriber domain according to embodiments herein.

FIG. 4 is an example diagram illustrating implementation of a blurring function to viewer images to protect privacy of respective one or more viewers in a subscriber domain according to embodiments herein.

FIG. 5 is an example diagram illustrating partitioning of blurred images into multiple display regions (such as quadrants) and monitoring of motion associated with respective viewers in a subscriber domain according to embodiments herein.

FIG. 6 is an example diagram illustrating monitoring of motion associated with one or more viewers in a respective subscriber domain according to embodiments herein.

FIG. 7 is an example diagram illustrating monitoring of motion associated with one or more viewers in a respective subscriber domain according to embodiments herein.

FIG. 8 is an example diagram illustrating generation and storage of viewer data indicating different types of reactions to advertisements such as whether a respective one or more viewers in a subscriber domain liked or disliked the advertisements according to embodiments herein.

FIG. 9 is an example diagram illustrating an example computer architecture operable to execute one or more operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

An image processing system receives images of one or more viewer viewing images on a display screen. All or a portion of the images are blurred to protect privacy of the one or more viewers. The image processing system monitors motion of the one or more viewers in the blurred images. Based on the monitored motion, the image processing system stores viewer data indicating a reaction of the one or more viewers viewing content on a display screen. In one embodiment, the video data indicates a degree to which the one or more viewers likes or dislikes content (such as one or more advertisements) displayed on the display screen.

As a more specific example, if the image processing system detects that motion in the blurred images includes one or more persons no longer viewing a display screen such as because they left a monitored region in front of the display screen, the image processing system stores data indicating that the one or more persons is not interested in the content. Conversely, if the image processing system detects that the blurred images includes one or more persons that watch the content in its entirety or a portion of a respective advertisement above a threshold value amount of time, the image processing system assumes that the one or more person is more likely interested in the displayed content and records same.

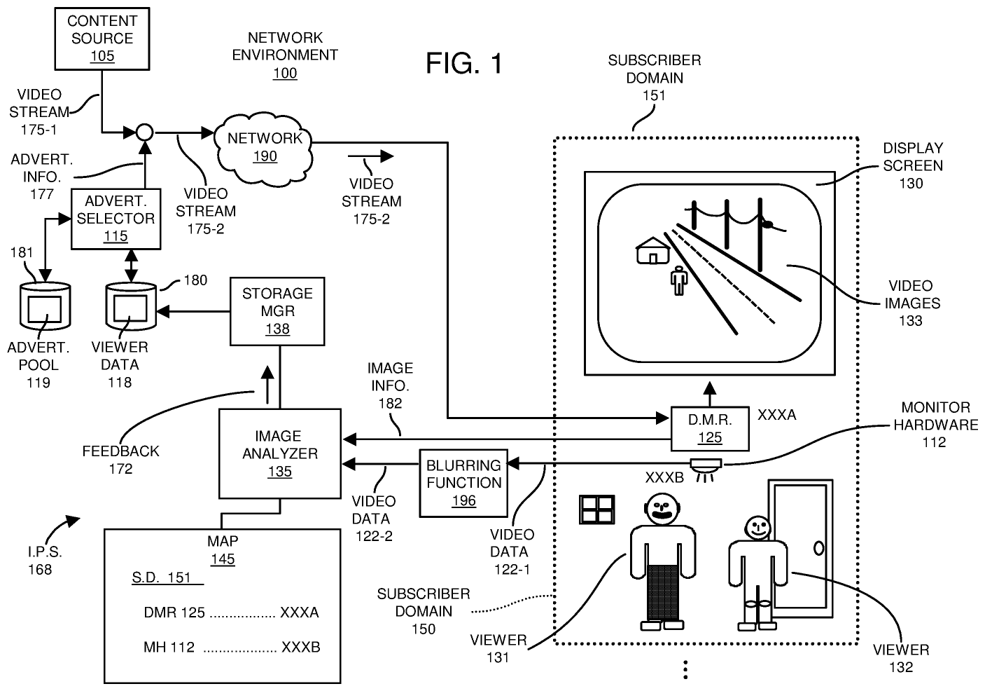

Now, more specifically, with reference to the drawings, FIG. 1 is an example diagram illustrating content distribution and analysis of blurred images of viewers according to embodiments herein.

As shown, network environment 100 includes image processing system 168 and multiple subscriber domains such as including subscriber domain 151. Image processing system 168 includes monitor hardware 112, blurring function 196, image analyzer 135, storage manager 138, repository 180, repository 181, advertisement selector 115, content source 105, and network 190.

As shown in this example embodiment, subscriber domain 151 includes display screen 130, display management resource 125 (assigned unique identifier value XXXA), and monitor hardware 112 such as one or more cameras (assigned unique identifier value XXXB).

Note that any of the resources as discussed herein can be configured as hardware, executed software, of a combination of hardware and executed software. For example, image processing system 168 can be configured as image processing hardware, image processing software, or a combination of image processing hardware and image processing software; blurring function 196 can be configured as blurring hardware, blurring software, or combination of blurring hardware and blurring software; display management resource can be configured as display management hardware, display management software, or a combination of display management hardware and display management software; image analyzer 135 can be configured as image analyzer hardware, image analyzer software, or a combination of image analyzer hardware and image analyzer software; storage manager 130 can be configured as storage manager hardware, storage manager software, or a combination of storage manager hardware and storage manager software; advertisement selector 115 can be configured as advertisement selector hardware, advertisement selector software, or a combination of advertisement selector hardware and advertisement selector software; and so on.

In this example embodiment, the viewer 131 (such as head-of-household or subscriber) controls operation of the display management resource 125 (such as set top box or other suitable resource) and corresponding video images 133 displayed on the display screen 130. For example, in response to selection of respective content, the display management resource 125 receives the requested content such as video stream 175-2 from the content source 105. Content source 105 transmits video stream 175-2 over network 190. The display management resource 125 receives the video stream 175-2 (such as selected content and advertisements) and displays it as video images 133 on the display screen 130.

In one embodiment, the video stream 175-2 includes requested content such as a movie. The video stream 175-2 includes the requested movie as well as corresponding advertisements selected by the advertisement selector 115.

During playback of the respective video stream 175-2 on the display screen 130 as video images 133, as its name suggests, the monitor hardware 112 monitors one or more attributes (such as motion) of the respective subscriber domain 151 and corresponding viewers 131, 132, etc. In such an instance, monitor hardware 112 (such as camera equipment) produces video data 122-1 such as multiple frames of images of the respective viewers 131, 132, etc., and communicates the video data 122-1 to the blurring function 196.

Note that the blurring function 196 can be disposed at any suitable location. For example, if desired, the blurring function 196 can be disposed in the monitor hardware 112 itself or disposed at a remote location at the image analyzer 135. If desired, the video data 122-1 can be encrypted prior to communication to blurring function 196. In such an instance, the blurring function 196 decrypts the receives video data 122-1.

As its name suggests, the blurring function 196 blurs the images associated with the video data 122-1. For example, the blurring function 196 produces video data 122-2, which is basically images of the subscriber domain 151 and corresponding viewers 131, 132, etc., in which all or a portion of the original images are blurred to protect privacy of the respective one or more viewers 131, 132, etc., in the subscriber domain 151 viewing the respective display screen 130.

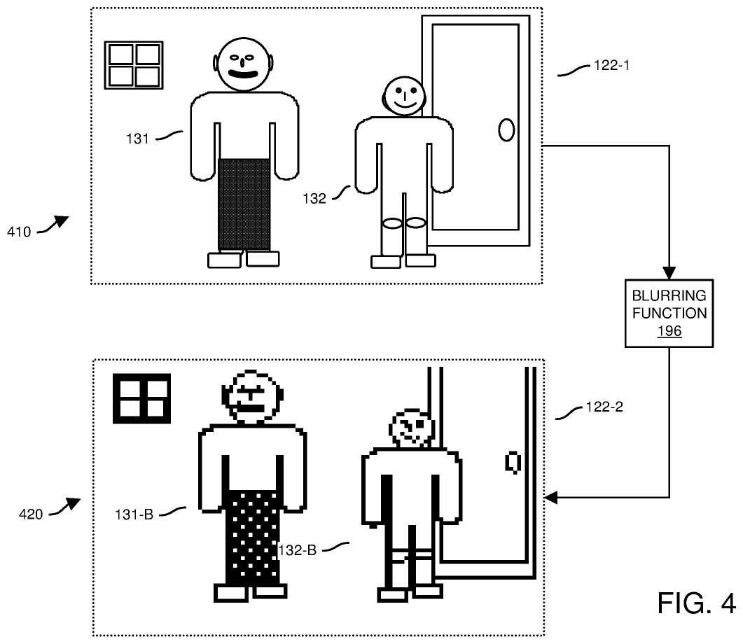

An example of blurring is described in FIG. 4 and corresponding text. In one embodiment, the blurring function 196 implements a gaussian color blurring function to the received video data 122-1 to produce video data 122-2. Although any suitable blurring function 196 that obscures identities can be used to blur images captured by the on hardware 112.

Thus, referring again to FIG. 1, one implementation of the network environment 100 includes an image processing system 168 such as including image analyzer 135 (such as hardware and corresponding executed software). The image analyzer 135 receives blurred images (such as video data 122-2) of one or more viewers in subscriber domain 151 viewing the display screen 130. As previously discussed, at least a portion of the images in the video data 122-1 (i.e., frames of images of the viewers over multiple sample times) are blurred to protect privacy of the one or more viewers.

In one embodiment, the blurring of the respective images of viewers 131, 132, etc., results in the inability to identify a specific identity of each of the viewers. However, the blurring of each viewer may result in the multiple blurred viewers being discernible with respect to each other, even though their identities are obscured. Thus, embodiments herein can include identifying a reaction of each viewer and, based on such information, determining which of the specific viewers in the subscriber domain 151 like or dislike each of the corresponding advertisements played back on the display screen 130.

In further example embodiments, the image analyzer 125 monitors an amount of motion of each respective viewer in the blurred images of video data 122-2. Based on the monitored and detected motion, and corresponding reaction of the at least one monitored viewer either remaining in the view of the monitor hardware 112 or exiting its view, the image analyzer 125 produces feedback 172 indicating a degree to which the respective one or more viewers 131, 132, etc., in subscriber domain 151 likes the corresponding advertisement content (such as video images 133) displayed on the display screen 130. Details of detecting motion associated with the blurred images further discussed below.

As a more specific example, as further discussed herein, if the image processing system 168 detects that motion in the blurred images of video data 122-2 indicate that a respective person such as viewer 131 no longer views a display screen 130 during playback of respective advertisement content on display screen 130, the image processing system 168 stores viewer data 118 indicating that the respective one or more person (of viewers) is not interested in the corresponding advertisement content being played back on the display screen 130. Conversely, if the image processing system 168 detects that the blurred images in video data 122-2 represents one or more persons (of viewers) who watches the advertisement content in its entirety (or large portion thereof above a threshold value) due to lack of motion of the respective one or more viewer, the image processing system 168 assumes that the respective one or more person is interested in the content and stores corresponding viewer data 118 indicating same.

As previously discussed, the image analyzer 135 can be configured to determine and track which of the blurred viewers likes or dislikes the played back advertisements based on their respective reactions to the played back content.

In a similar manner, the image processing system 168 determines whether one or more of the viewers in each of multiple different subscriber domains in network environment 100 is interested in the advertisement content being played back on respective display screen.

For example, the image processing system 168 monitors a reaction (such as motion or other one or more attributes in and out of the monitored region of subscriber domain 150) of the viewers in subscriber domain 151 for each instance of playing back a respective advertisement segment (such as 10, 20, 30, etc., second advertisements) on the display screen 130.

In one embodiment, the image analyzer 135 is made aware of the corresponding advertisement played back as video images 133 on the display screen 130 via image information 182 communicated from the display management resource 125 or other suitable entity. In one embodiment, the image information 182 indicates a specific identity of the advertisement played back of the display screen 130 during monitoring. Accordingly, in one embodiment, the image analyzer 135 receives notification of an identity of a respective advertisement played back on the display screen 130.

In further example embodiments, the image processing system 168 is further operative to produce subscriber account information (such as map information 145) to include an identity XXXB of video equipment (such as monitor hardware 112 such as video monitoring equipment) operated in the subscriber domain 151 to an identity of the display screen 130 and/or display management resource 125 (such as XXXA) in the subscriber domain 151. Thus, in one embodiment, the map information 145 keeps track of which instance of the monitor hardware 112 and which instance of the display management resource 125 is present in a subscriber domain.

More specifically, in one embodiment, the map information 145 indicates that the display management resource 125 and/or display screen 130 in subscriber domain 151 is assigned a unique identifier value of XXXA. The map information 145 also indicates that the monitor hardware 112 is assigned the unique identifier value of XXXB.

In one embodiment, the image information 182 associated with content playback as image 133 on the display screen 130 is tagged with a value of XXXA associated with the display management resource 125 and/or display screen 130; the video data 122-2 is tagged with a value of XXXB. In such an instance, via map information 145, the image analyzer 135 is able to identify that video data 122-2 tagged with XXXB pertains to playback of corresponding advertisement information tagged with XXXA of subscriber domain 151 as indicated by image information 182.

As previously discussed, the image analyzer 135 analyzes the blurred images of the viewers 131, 132, etc., for each of multiple different instances of advertisements and stores such resulting like/dislike data (such as viewer data) for each advertisement as viewer data 118 in repository 180.

After collecting and storing appropriate viewer data 118 in repository 180 over time, the advertisement selector 115 uses the viewer data 118 as a basis to identify additional advertisements for communicating in the video stream 175-2 to the subscriber domain for playback on the display screen 130.

For example, the initial analysis of blurred images and video data 122-2 may indicate that the one or more viewers in the subscriber domain 151 are amenable to viewing a full-length of automobile advertisements but are uninterested in skincare product advertisements. In such an instance, based on reactions such as motion of the viewers, in response to determining that the viewers in subscriber domain like automobile commercials as indicated by the viewer data 118, the advertisement selector 115 selects previously displayed automobile advertisements or not yet viewed automobile advertisements for transmission in appropriate time slots of the video stream 175-2 (or other video stream data) for display of selected advertisements on display screen 130.

More specifically, content source 105 produces video stream 175-1 to include one or more advertisement windows in which to populate respective one or more advertisements (content) selected by the advertisement selector 115. Advertisement selector 115 retrieves the advertisements from advertisement pool 119 and embeds the selected advertisement as indicated by the advertisement information 177 in the appropriate windows of the video stream 175-1 to produce the video stream 175-2.

In a manner as previously discussed, the display management resource 125 initiates display of the selected one or more advertisements in video stream 175-2 on the display screen 130 while the monitor hardware 112 again monitors respective motion associated with viewers in the subscriber domain 151 watching the display screen 130 and corresponding playback of advertisement in time slots of played back content. In a similar manner, the image analyzer 135 analyzes respective responses by the viewers and updates viewer data 118 to indicate a degree to which one or more viewers in the subscriber domain 151 like the advertisements in the video stream 175-2.

Note that any suitable scale (such as a range from 0 to 100 or other suitable values) can be used to indicate a degree of whether occupants of the subscriber domain 151 like a respective advertisement played back on the display screen. For example, a value of 0 to 50 indicates that none or few of the occupants in the subscriber domain 151 like a respective advertisement. Conversely, assignment of a value such as greater than 50 and up to 100 indicates that the respective one or more occupants in the subscriber domain 151 like type of advertisement.

In one embodiment, the display management resource 125 notifies the image analyzer 135 of the window of time in which each advertisement is played back on the display screen 130. The video 122-2 includes blurred images tagged with value XXXB as well as time stamp information indicating which portions of the video images 133 on display screen 130 represent the corresponding advertisement being played back. This ensures that the image analyzer 135 analyzes motion of the viewers at appropriate times.

If desired, the advertisement selector 115 can be configured to categorize the content typically played back by the viewers in the subscriber domain 151 and compare to other viewers selecting similar content for playback in other subscriber domains and use viewer data of liked advertisement from the other subscriber domains as a basis to select an advertisement for playing back on the display screen 130 in subscriber domain 151.

In still further example embodiments, the image analyzer 125 analyzes egress patterns of the one or more viewers in the subscriber domain 151 based on: i) an identity of the display screen 130 and/or display management resource 125 assigned unique identifier value XXXA, ii) a genre of the advertisement content or selected title of content displayed on the display screen 130, and iii) a time of the advertisement content or selected title of content being displayed on the display screen 130.

Further, the image analyzer 135 as discussed herein can be configured to compare historical patterns for a viewer viewing the content on display screen 130 in subscriber domain 151 to other subscribers and to their personal historical viewings of content and uses such information as a basis to select an advertisement for playback on the display screen 130 in the subscriber domain 151.

In further example embodiments, via analysis of the blurred images and monitored motion associated with video data 122-2, the image analyzer 135 or other suitable entity determines a probability that a corresponding one or more viewers viewing the display screen 130 will discontinue viewing the display screen 130 during display of a particular advertisement (i.e., content) on the display screen 130. In one embodiment, the image analyzer 135 selects a subsequent advertisement to include in video stream 175-2 to display on the display screen 130 based on the stored viewer data 118 indicating the degree to which the at least one viewers in subscriber domain 151 liked the advertisement content previously displayed on the display screen 130. Thus, if the image analyzer 135 detects that one or more viewers in the subscriber domain 151 like playback of a first advertisement (in video stream 175-2) on the display screen 130, the advertisement selector 115 receives feedback of this condition and selects an advertisement from a similar genre of the first advertisement for display on the display screen 130.

More specifically, if the feedback from the image analyzer 135 indicates that the viewers like a first automobile advertisement, the advertisement selector 115 selects a second advertisement (such as automobile commercial from a different company than the first automobile advertising) from advertisement pool 119 and populates the video stream 175-2 with the second automobile advertisement for subsequent display on the display screen 130.

Note that the occupants of the subscriber domain 151 may be made aware of the fact that they are being monitored the monitor hardware 112. For example, in one embodiment, the service provider (such as providing video stream 175-2 for playback) may provide a respective incentive for the viewers to be monitored in the subscriber domain 151 such as providing a lower cost subscription to receive content from the content source 105. In such an instance, the service provider notifies the respective occupants of subscriber domain 151 that their personal information (identities and actions in their home) are protected because only blurred images are used to determine the effectiveness of a respective advertisement playing back on the display screen 130.

Another possible incentive for the occupants of subscriber domain 151 to sign up for viewer monitoring as described herein (via monitor hardware 112) is the benefit of playing back fewer advertisements in respective video stream 175-2. For example, if a respective subscriber domain and corresponding occupants do not sign up for a monitoring service via monitor hardware 112, the amount of advertisement content may be 30 percent of the video stream 175-2. This means the viewers watch advertisements for 30% of the playback time associated with the video stream 175-2. Conversely, if the occupants of the subscriber domain 151 sign up for the respective service and blurring of images to protect privacy, the service provider may reduce the amount of advertisement content in the video stream 175-2 to a value of 20 percent or other suitable value.

Thus, the occupants of the subscriber domain 151 may benefit from signing up for the monitoring service provided by the monitor hardware 112 and image processing system 168 by having to watch a lower percentage of advertisements embedded in requested program content (such as requested movie content). That is, the playback time of video stream 175-2 to subscriber domain 151 includes advertisements being played back 20% of the time instead of 30% of the time.

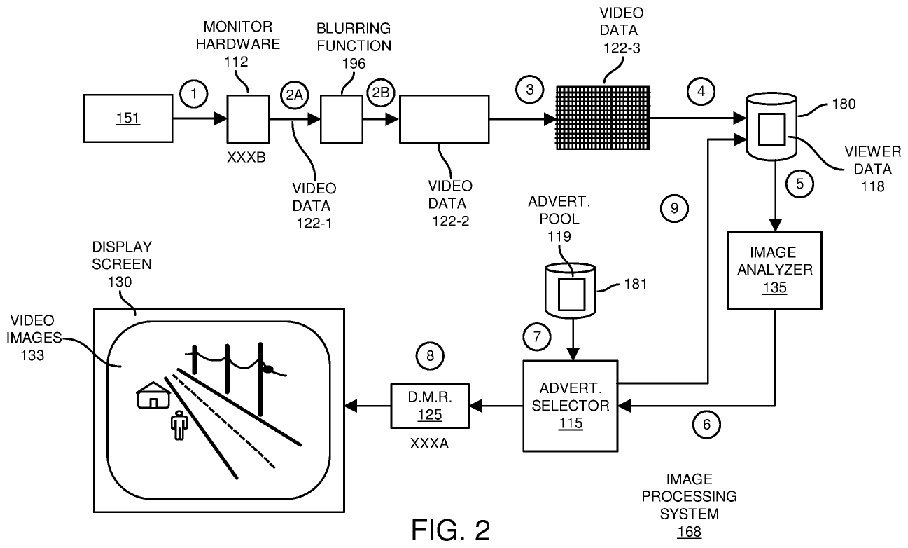

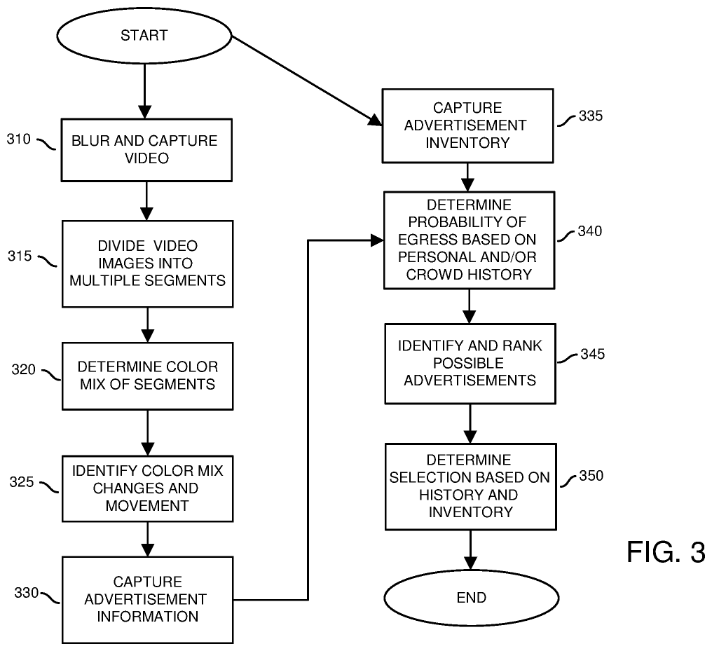

FIG. 2 is an example diagram illustrating image processing and advertisement selection flows according to embodiments herein.

In operation #1, in a manner as previously discussed, monitor hardware 112 monitors multiple viewers in subscriber domain 151.

In operation #2A, the monitor hardware 112 generates video data 122-1 representing images of corresponding one or more viewers watching images on display screen 130. In one embodiment, the monitor hardware 112 (such as camera equipment) sends the video data 122-1 (feed) to the blurring function 196.

In operation #2B, the blurring function 196 applies a blur so that no person or location associated with the subscriber domain 151 can be identified from the received video data 122-1. As previously discussed, in one embodiment, the content (images 133) on the display screen 130 is an advertisement displayed on the display screen 130. The monitor hardware 112 (monitoring device such as a video monitoring camera) produces video data 122-1 (such as multiple frames of images) of the one or more viewers watching the content played back on the display screen 130. The image blurring function (such as one or more of blurring function application, blurring function hardware, etc.) applies a blur to the video images in video data 122-1 of the at least one viewer watching the advertisement on the display screen 130 to protect an identity of the at least one viewers in the subscriber domain 151.

In processing operation #3, via partitioning by the image analyzer 135 or other suitable entity, the one or more blurred images are broken up into segments. In one embodiment, the color (such as by pixel) of each respective image is mapped to all possible colors and color percentage for each segment is determined.

In processing operation #4, in one non-limiting example embodiment, the color percentage along with metadata (e.g., time, category) is stored in the repository 180 (such as cloud based, local, etc.).

In processing operation #5, the image analyzer 135 performs a segment by segment comparison of one image to the next in the video data 122-2 to determine movement associated with the monitored viewers. The grid of video is associated with the monitor hardware 112 that is stationary in the subscriber domain 151. Thus, in one embodiment, although the images of viewers are blurred, the image analyzer 135 identifies a respective object (multiple pixels) as being a person based on a respective shape defined by one or more colors. Movement of the regions of colors from one partition (segment) to another in a grid of pixels captured by the monitor hardware 112 indicates motion of the viewer in the subscriber domain 151.

In processing operation #6, the image analyzer 135 communicates the detected motion associated with the one or more viewers in the subscriber domain 151 to the advertisement selector 115.

In processing operation #7, repository 181 stores an inventory of advertisements (pool of advertisement 119). In one embodiment, the advertisement selector 115 or other suitable entity determines a probability of a person staying or leaving based on an individual and/or others with similar history (such as when there is not sufficient data to determine what an individual might do).

In processing operation #8, the advertisement selector 115 communicates the selected advertisement from pool 119 to display management resource 125 for presentation on display screen 130.

FIG. 3 is an example diagram illustrating flow control associated with analyzing blurred images and providing appropriate advertisements to a subscriber domain according to embodiments herein.

In processing operation 310, the image processing system 168 captures video of viewers and blurs the images in a manner as previously discussed.

In processing operation 315, the image processing system 168 divides each of the video images into multiple segments.

In processing operation 320, the image processing system 168 determines color or shade (such as between pure white and pure black) mixes present in the segments from one image to the next.

In processing operation 325, the image processing system 168 identifies color or shade mix changes in the different segments over time to detect movement.

In processing operation 330, the image processing system 168 captures advertisement information.

In processing operation 335, the image processing system 168 captures advertisement inventory.

In processing operation 340, the image processing system 168 determines the probability of egress from view of the monitor hardware 112 for playback of a given advertisement based on personal and/or crowd history.

In processing operation 345, the image processing system 168 identifies and ranks possible advertisements for distribution to the subscriber domain and playback on the display screen 130.

In processing operation 350, the image processing system 168 determines selection based on history and/or available inventory of advertisements.

FIG. 4 is an example diagram illustrating implementation of a blurring function to viewer images to privacy of respective viewers in a subscriber domain according to embodiments herein.

In this example embodiment, the monitor hardware 112 produces the video data 122-1 to include image 410. Each of the viewers 131, 132, etc., in the image 410 is recognizable prior to application of the blurring function 196.

As previously discussed, the blurring function 196 receives the video data 122-1 produced by the monitor hardware 112 and applies a blur to all or a portion of the respective received image 410 to produce image 420 of unrecognizable viewers. Note again that, in one embodiment, although the viewers in the image will 420 are unrecognizable from a standpoint of their identity, the blurred viewer 131-B and viewer 132-B in image 420 are recognizable as human beings.

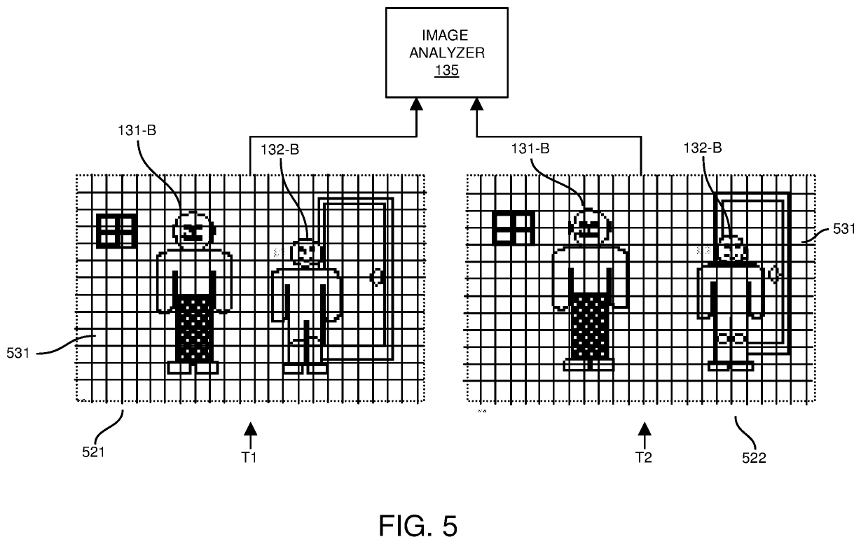

FIG. 5 is an example diagram illustrating partitioning of blurred images into multiple display regions and monitoring of motion associated with respective viewers in a subscriber domain according to embodiments herein.

In this example embodiment, the blurring function 196 produces images of viewers watching playback of the video images 133 (advertisement or other content) on the display screen 130.

For example, the blurred image 521 in FIG. 5 illustrates a first viewer 131-B at a first location (such as multiple quadrants or display regions of grid 531) of image 521 (image associated with video data 122-2) taken at time T1 during respective playback of an advertisement on display screen 130.

The blurred image 522 in FIG. 5 illustrates a second viewer 132-B at a second location (such as multiple quadrants or display regions of grid 531) of image 522 (image associated with video data 122-2) taken at time T2 during respective playback of an advertisement on display screen 130.

In order to determine motion of the one or more blurred viewers in the subscriber domain 151 as depicted in images 521 and 522, the image analyzer 135 partitions each of the blurred images 521 and 522 into multiple regions and then identifies differences amongst the blurred images over time via comparison of segments of image 521 to corresponding segments in image 522.

In this example embodiment, as detected by the image analyzer 135, the pixel settings in in first segments of image 521 representing the viewer 131-B substantially match the pixels settings associated with the same first segments of image 522 representing the viewer 131-B. Via such analysis, the image analyzer 135 notes that the viewer 131-B continues to watch the advertisement or has not moved.

Further in this example embodiment, the pixel settings in second segments of image 521 representing the viewer 132-B do not match the pixels settings associated with second segments of image 522. Via such analysis, the image analyzer 135 notes that the viewer 131-B has moved from one location to another in grid 531 because the segments associated with user 132-B in image 522 reside in a different location of grid 531 than the image of voltage 132-B associated with the image 522. In one embodiment, motion of the viewer 132-B indicates that the viewer 132 is not interested in the advertisement displayed on the display screen 130.

Thus, the blurred images associated with video data 122-2 include at least a first blurred image 521 of the one or more viewers viewing the display screen 130 at a first instant in time T1 and a second blurred image 522 of the one or more viewers viewing the display screen 130 at a second instant in time T2. The image analyzer 135 partitions the first blurred image 521 into first display regions (according to grid 531) and partitions the second blurred image 522 into second display regions (according to grid 531). The image analyzer 135 then compares the first display regions to the second display regions to identify the motion of the one or more viewers in a manner as previously discussed.

Further embodiments herein include, via the image processing system 168 and corresponding image analyzer 135, determining a type of motion of the respective one or more viewers based on identification of a size of a display region representing movement of the viewer in multiple different timeframes (such as T1 and T2) of the blurred images in board 122-2.

For example, assume that the viewer 132B appears shorter (and smaller in size) in image 521 because the viewer is sitting. Via analysis by the image analyzer 135, the image analyzer 135 detects that the viewer 132B appears shorter (and smaller in size) in image 521 than in image 522 because the viewer 132B is sitting in image 421 and standing in image 522.

Note that further embodiments herein include implementing body or body part recognition (such as head, arms, torso, legs, etc.) and detecting each viewer in the images as being an object and monitoring motion of such viewers based on detecting that one or more bodies or body parts associated with the body of viewer 132-B moves from one location to another between time T1 and time T2 as indicated by the difference in image 522 with respect to image 521 (base blurred image).

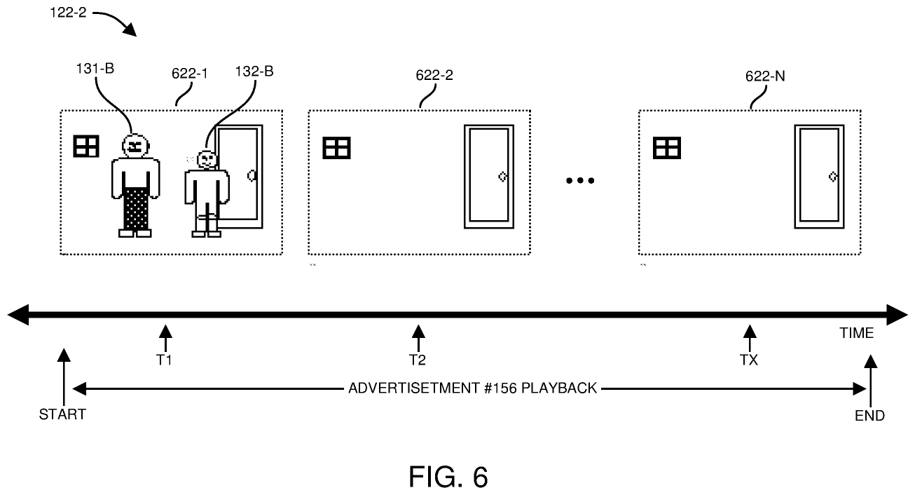

FIG. 6 is an example diagram illustrating monitoring of motion associated with one or more viewers in a respective subscriber domain according to embodiments herein.

In still further example embodiments, the image analyzer 135 monitors the motion in one or more blurred images 622-1, 622-2, etc., via detecting a change in pixel setting patterns (such as based on pixel color, pixel intensity, etc.) in the blurred images to determine states of motion associated with the one or more viewers 131-B, 132-B, etc.

In one embodiment, the change in pixel settings (or object outlines) in the blurred images 622 indicates a first viewer of the at least one viewer no longer viewing the display screen 130. In other words, prior to the advertisement #156 being played back on the display screen 130 in its entirety by time Tx, the image analyzer 135 detects that the viewer 132-B is no longer viewing the display screen 130 at time T2 (very near the start of the playback of the advertisement #156).

Further embodiments herein include, as previously discussed, via the image analyzer 135, storage manager 138 or other suitable entity, storing viewer data 118 indicating the degree (such as a binary value such as like or dislike, or a value selected from a range) to which the at least one viewer 131, 132, etc., likes or dislikes the advertisement #156 (content) displayed on the display screen 130. As previously discussed, the determination of whether occupants such as viewers of the subscriber domain 151 like or dislike a respective advertisement played back on the display screen 130 depends upon their corresponding detected motions.

In one embodiment, the storage manager 138 records attributes of the advertisement #156 displayed on the display screen 130 at one or more different instants of time over the time duration between the start and end of the advertisement #156. Via analysis of the sequence of blurred images 622 of the one or more viewers viewer viewing the display screen 130 over the time duration, the image analyzer 135 records corresponding motion associated with the viewers at each of the multiple instants of time.

In this example embodiment, as previously discussed, the viewer 132-B and viewer 131-B are noted by the image analyzer 135 as being missing from the blurred image 622-2 taken at time T2. This means that the viewers 131-B and 132-B discontinued viewing playback of the advertisement #156 on the display screen 130 just after initial playback of the advertisement #156. In such an instance, the image analyzer 135 produces feedback indicating that neither of the viewers 131-B and 132-B were not interested in the advertisement #156.

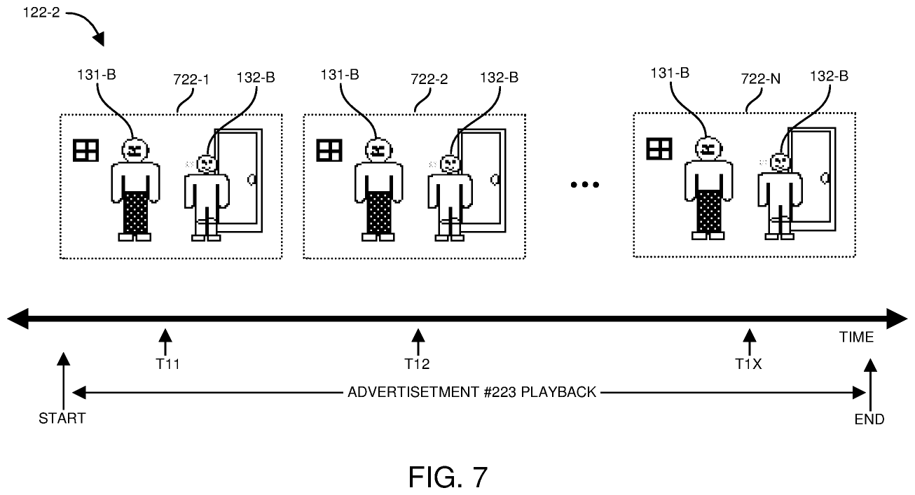

FIG. 7 is an example diagram illustrating monitoring of motion associated with one or more viewers in a respective subscriber domain according to embodiments herein.

In still further example embodiments, the image analyzer 135 monitors the motion in blurred one or more images 722-1, 722-2, etc., (such as associated with video data 122-2) via detecting a change in pixel setting patterns (such as based on pixel color, pixel intensity, etc.) in the blurred images to determine states of motion associated with the one or more viewers 131-B, 132-B, etc.

In one embodiment, there is generally no change in pixel settings (or object outlines) in the blurred images 722, indicating that both viewers watch the advertisement #223 between time T11 and T1x.

Further embodiments herein include, as previously discussed, via the image analyzer 135, storage manager 138 or other suitable entity, storing viewer data 118 indicating the degree to which the at least one viewer 131, 132, etc., likes or dislikes the advertisement #223 (content) displayed on the display screen 130.

In one embodiment, the storage manager 138 records attributes of the advertisement #223 displayed on the display screen 130 at multiple different instants of time over the time duration between the start and end of the advertisement #223. Via analysis of the sequence of blurred images 622 of the one or more viewers viewer viewing the display screen 130 over the time duration T11 to T1X, the image analyzer 135 records corresponding lack of motion associated with the viewers at each of the multiple instants of time.

Because both viewers watch the advertisement #223 in its entirety, or an amount greater than a threshold value, the image analyzer 135 produces feedback indicating that the viewers in subscriber domain 151 are interested in the advertisement #223.

Further embodiments herein include detecting conditions in which a respective viewer 131 initially starts to leave the region monitored by the monitor hardware 112, but then stays and watches an entirety of a respective advertisement displayed on the display screen 130. In such an instance, this condition indicates that something in the advertisement #223 played back on display screen 130 caught the attention of the respective viewer 131. In response to detecting this condition (such as physical gesture in which the viewer initially leaves and then returns to view the advertisement #223), the image analyzer 135 produces the respective viewer data 118 to indicate that the viewer 131 (or subscriber domain 151 in general) likes the advertisement #223.

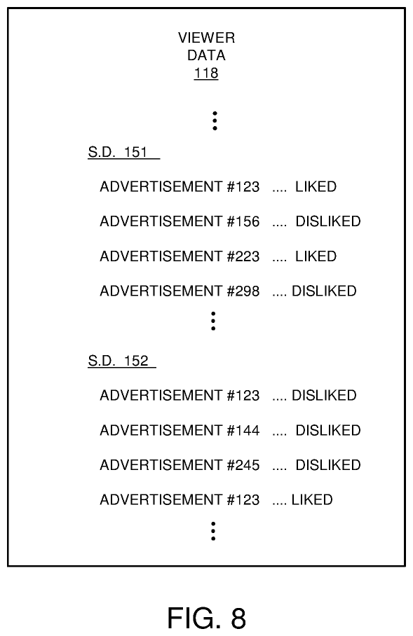

FIG. 8 is an example diagram illustrating viewer data indicating different types of advertisements liked/disliked by respective viewers in a subscriber domain according to embodiments herein.

As previously discussed, the image processing system 168 produces viewer data 118 indicating which of multiple different types of advertisements played back on the display screen 130 are liked and disliked by the respective viewers in the subscriber domain 151 based on respective reactions of the viewers. Also, as previously discussed, the reactions of the viewers are determined based upon corresponding motion detected the monitor hardware 112. More specifically, in one embodiment, the detection that all of the viewers exit the viewing region of monitor hardware 112 (such as no longer in view) indicate that the viewers in subscriber domain 151 do not like the respective advertisement being played back. Conversely, detection that all of the viewers remaining in view of the monitor hardware 112 and captured by the viewing data 122-2 for a duration of the advertisement being played back indicates that those viewers in the subscriber domain 151 like the respective advertisement.

In this example embodiment, based on the motion analysis of blurred images of the viewers at different times, the viewer data indicates that viewers in the subscriber domain 151 liked advertisement #123, #223, etc., and viewers in subscriber domain disliked advertisement #156, #298, etc.

In one embodiment in which the image analyzer 135 is able to discern between the different blurred images of viewers, the image analyzer 135 provides feedback 172 indicating which of the viewers likes each particular advertisement and which of the viewers dislikes each particular advertisement.

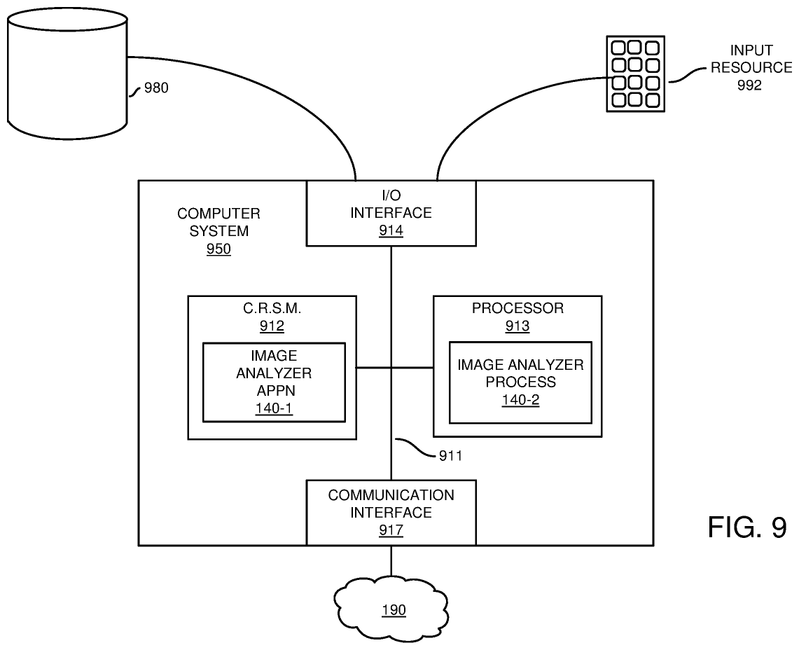

FIG. 9 is an example block diagram of a computer system for implementing any of the operations as previously discussed according to embodiments herein.

Any of the resources (such as image analyzer 135, blurring function 196, monitor hardware 112, image processing system 168, advertisement selector 115, content source 105, etc.) as discussed herein can be configured to include computer processor hardware and/or corresponding executable instructions (such as management application 140-1) to carry out the different operations as discussed herein.

As shown, computer system 950 of the present example includes an interconnect 911 that coupling computer readable storage media 912 such as a non-transitory type of media (which can be any suitable type of hardware storage medium in which digital information can be stored and retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with management application 140-1 (e.g., including instructions) to carry out any of the operations as discussed herein.

During operation of one embodiment, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute management application 140-1.

In accordance with different embodiments, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

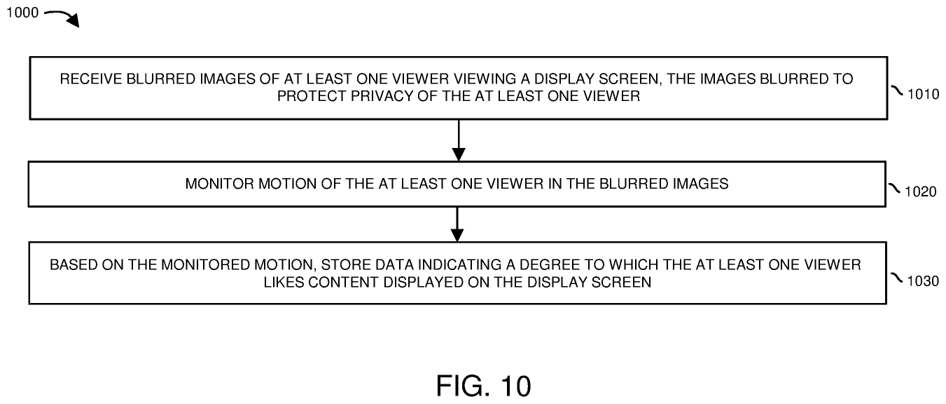

Functionality supported by the different resources will now be discussed via flowcharts in FIG. 10. Note that the steps in the flowcharts below can be executed in any suitable order.

FIG. 10 is a flowchart 1000 illustrating an example method according to embodiments. Note that there will be some overlap with respect to concepts as discussed above.

In processing operation 1010, the image analyzer 135 receives blurred images (video data 122-2) of the one or more viewers 131, 132, etc., viewing the display screen 130. The images in video data 122-2 are blurred to protect privacy of the viewers 131, 132, etc.

In processing operation 1020, the image analyzer 135 monitors motion of the one or more viewers 131, 132, etc., in the blurred images of video data 122-2.

In processing operation 1030, based on the monitored motion, the image analyzer 135 stores viewer data indicating a degree to which the one or more viewers likes content (such as images 133) displayed (such as played back) on the display screen 130.

### Further Embodiments

In further example embodiments, the linkage of a viewer to a camera/television (such as monitor hardware 112 and display screen 130) include one or more of the following operations:
The linkage of a person to a camera goes under the math/science that a person's image being captured by the camera would consistently take up the same amount of space as the camera focal is fixed.
When no person (viewer) is present in the region monitored by the monitor hardware 112, which would be a majority of the time, there would be no movement detected in video data 122-2 and the blurred images (such as colors) associated with the subscriber domain 151 are captured via the monitor hardware 112.
When a person enters the room, certain embodiments herein can include changing a number of quadrants (partitions) that the received blurred images in video data 122-2 are divided into. For example, if a respective image is a I have 100 quadrants covered 10×10 in an image, as a voltage moves into the focal of the camera (monitor hardware 112), the number of quadrants that the viewer is occupying can be determined based on the color changes from a respective base image. So for example, a viewer may occupy 20 quadrants of the image while sitting or 40 quadrants of the image while standing.
As the color pattern changes in the received blurred video data 122-2, the image analyzer 135 determines standing/sitting as the movement in subscriber domain 151 is fully contained inside the lens focal, so it is not another person entering the location (subscriber domain 151).
Characteristics of a respective viewer can be tracked to indicate occupation in 20 or 40 quadrants (and actually list the quadrants). As time passes, so does the base of the data that is used to track the viewer.
In addition, note further that the image analyzer 135 and corresponding image processing system 168 can be trained with no viewers in the monitored region of the subscriber domain 151 to recognize chairs/couches (or other stationary objects) inside the focal view of the monitor hardware 112. Movement in front of the stationary objects indicates that the viewer is potentially sitting or standing in front of those objects.
In further example embodiments, as previously discussed, attributes of a respective viewer such as size, shape, color, etc., are logged into the image processing system 168 at particular one or more locations in the monitored region of subscriber domain 151. Such information is linked to the television show and corresponding advertisement conveyed in the video stream 175-2.

Thus, in contrast to conventional techniques, embodiments herein include: i) analyzing blurred images of individuals watching television and determine via color movements inside that blur that a person has left the room and is no longer watching, and ii) comparing patterns for individuals for specific channels and determining the similarity of audience members to determine optimal selection of a commercial for a particular television audience.

In further example embodiments, another point of novelty of embodiments herein include comparing people with similar habits for leaving to predict recommendations when there is not a statistically valid base to use. For example, if a viewer leaves the monitored region (room) for commercial types A, B, C, D, E for a given genre of shows and the image analyzer 135 has never detected advertisement E but leaves for advertisements A, B, C, D, there is an increased probability that for the same genre, the corresponding viewer would leave for advertisement E also so it wouldn't be recommended for playing back to the viewer. On the anti-pattern, if the viewer watches advertisement G and the viewer has never seen a G commercial, it would increase the probability that viewer would watch it. This provides a base to train the image analyzer system.

The blurred image is taken, for argument sake of the area in front of a television. Movement patterns of the blurred color are used to track movement. So if I'm wearing a red shirt and blue jeans sitting on a white couch, the system would do image compares and see the red/blue image moving with more white showing. The reason for this blurring is to protect privacy so that no individual can be identified as leaving or even watching a show. So if you see that someone (me) is walking out on dog food commercials at a rate over a pre-defined threshold, you can then remove dog food commercials from being shown on my TV.

### METHOD TO CAPTURE VIDEO FEED

This method teaches how to register and provide a private feed to the system.
Subscriber registers for dynamic advertisement
Subscriber enters IoT enabled cameras into the system, including access privileges and addresses
When television is on, system captures video feed from one or more IoT enabled cameras
Prior to storing in non-transient memory, the system applies a Gaussian blur to the feed

### METHOD TO DETERMINE IF A PERSON LEAVES THE ROOM

This method teaches how to utilize the video feed to determine if movement suggests that a person has left the room. Based on the use case model, this does not need to be 100% accurate.
System breaks up the video feed into multiple segments (e.g. 10×10 blocks)
If multiple video feeds are enabled for a single receiving set, each set is given a weighting based on the profile (or divided equally if no specific allocation given)
For each segment, the system compares the color mix of the segment
For each segment, the system determines if the color mix has changed from previous captured image
For each time the system determines that a color mix has changed, the system compares changes in the color mix to neighboring segments to determine if the object is moving from one segment to another or out of the range
System logs all movements and non-movements
Preferred embodiment would be a blockchain which could track movements and later advertisements

### METHOD TO CAPTURE SUBSCRIBER TELEVISION USAGE

This method teaches how to determine what channel, time, and show are presented for future analysis
System stores in non-transient memory show, television set time, and category of the show
System tracks start/end time for each set/show being shown
Shows are categorized using standards (e.g. sports, comedy, kids show) displayed in guide

### METHOD TO DYNAMICALLY SELECT COMMERCIAL

This method teaches how to determine what advertisement should be shown based on comparison to individual and crowd-sourced (based on similar historical patterns). Weighting of the 2 sources is configurable.
System compares historical actions for a television set/subscriber to identify trends for a given classification of commercials (e.g. pharmacy, beer, future shows)
Based on the probability (consistency) of an action, the confidence factor is modified
System identifies other subscribers with similar historical records for a time/show category to determine probability of a person leaving for a given classification of commercials
System compares historical actions to available pool of commercials and ranks the commercials with the highest probability of being watched
System filters ranked commercials to exclude commercials that don't meet the threshold (probability) based on the advertiser's threshold
System analyzes historical usage for a given commercial to determine probability that all commercials for a given advertisement will be used within the given timeslot
System modifies ranking, based on weight given to usage vs watching probability as configured.

Note again that techniques herein are well suited to facilitate more efficient advertising while protecting viewer privacy in a network environment via implementation of one or more blurring function. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving blurred images of at least one viewer viewing a display screen, the images blurred to protect privacy of the at least one viewer;
monitoring motion of the at least one viewer in the blurred images; and
based on the monitored motion, storing viewer data indicating a reaction of the at least one viewer viewing content displayed on the display screen.

2. The method as in claim 1 further comprising:
determining a type of motion of a first viewer of the at least one viewer based on identification of a size of a display region representing movement of the first viewer in multiple different timeframes of the blurred images.

3. The method as in claim 1, wherein the content is an advertisement displayed on the display screen, the method further comprising:
producing the blurred images via application of a blur function to video images of the at least one viewer watching the advertisement on the display screen.

4. The method as in claim 1, wherein the display screen resides in a subscriber domain, the method further comprising:
producing subscriber account information to include an identity of video equipment operated in the subscriber domain to an identity of the display screen in the subscriber domain, the blurred images derived from video images of the at least one viewer viewing the display screen.

5. The method as in claim 1, wherein monitoring the motion includes detecting a change in color patterns in the blurred images.

6. The method as in claim 5, wherein the change in color patterns in the blurred images indicates a first viewer of the at least one viewer no longer viewing the display screen.

7. The method as in claim 1, wherein monitoring motion of the at least one viewer in the blurred images includes:
partitioning the blurred images into multiple regions; and
identifying differences amongst the blurred images, the identified differences indicating motion of a first viewer of the at least one viewer.

8. The method as in claim 1, wherein the blurred images include a first blurred image of the at least one viewer viewing the display screen at a first instant in time and a second blurred image of the at least one viewer viewing the display screen at a second instant in time, the method further comprising:
partitioning the first blurred image into first display regions;
partitioning the second blurred image into second display regions; and
comparing the first display regions to the second display regions to identify the motion of the at least one viewer.

9. The method as in claim 1, wherein storing viewer data indicating the reaction of the at least one viewer viewing content displayed on the display screen includes:
recording attributes of the content displayed on the display screen at multiple different instants of time over a time duration; and
via analysis of the blurred images of the at least one viewer viewing the display screen over the time duration, recording corresponding motion associated with the content for each the multiple instants of time.

10. The method as in claim 1 further comprising:
analyzing egress patterns of the at least one viewer based on: i) an identity of the display screen, ii) a genre of the content displayed on the display screen, and iii) a time of the content being displayed on the display screen to historical patterns.

11. The method as in claim 1 further comprising:
comparing historical patterns for a viewer to other subscribers and to their personal historical viewing of the display screen.

12. The method as in claim 1 further comprising:
via analysis of the blurred images and monitored motion, determining a probability that a viewer of the display screen will discontinue viewing the display screen during display of a particular advertisement on the display screen.

13. The method as in claim 1 further comprising:
selecting an advertisement display on the display screen based on the stored viewer data indicating the reaction of the at least one viewer viewing the content previously displayed on the display screen.

14. A system comprising:
image analyzer hardware operative to:
receive blurred images of at least one viewer viewing a display screen, the images blurred to protect privacy of the at least one viewer;
monitor motion of the at least one viewer in the blurred images; and
based on the monitored motion, store viewer data indicating a reaction of the at least one viewer viewing content displayed on the display screen.

15. The system as in claim 14, wherein the image analyzer hardware is further operative to:
determine a type of motion of a first viewer of the at least one viewer based on identification of a size of a display region representing movement of the first viewer in multiple different timeframes of the blurred images.

16. The system as in claim 14, wherein the content is an advertisement displayed on the display screen, the image analyzer hardware further operative to:
produce the blurred images via application of a blur function to video images of the at least one viewer watching the advertisement on the display screen.

17. The system as in claim 14, wherein the display screen resides in a subscriber domain, the image analyzer hardware further operative to:
produce subscriber account information to include an identity of video equipment operated in the subscriber domain to an identity of the display screen in the subscriber domain, the blurred images derived from video images of the at least one viewer viewing the display screen.

18. The system as in claim 14, wherein the image analyzer hardware is further operative to detect the motion via a detected change in color patterns in the blurred images.

19. The system as in claim 18, wherein the detected change in color patterns in the blurred images indicates a first viewer of the at least one viewer no longer viewing the display screen.

20. The system as in claim 14, wherein the image analyzer hardware is further operative to:
partition the blurred images into multiple regions; and
identify differences amongst the blurred images, the identified differences indicating motion of a first viewer of the at least one viewer.

21. The system as in claim 14, wherein the blurred images include a first blurred image of the at least one viewer viewing the display screen at a first instant in time and a second blurred image of the at least one viewer viewing the display screen at a second instant in time, the image analyzer hardware further operative to:
partition the first blurred image into first display regions;
partition the second blurred image into second display regions; and
compare the first display regions to the second display regions to identify the motion of the at least one viewer.

22. The system as in claim 14, wherein the image analyzer hardware is further operative to:
record attributes of the content displayed on the display screen at multiple different instants of time over a time duration; and
via analysis of the blurred images of the at least one viewer viewing the display screen over the time duration, record corresponding motion associated with the content for each the multiple instants of time.

23. The system as in claim 14, wherein the image analyzer hardware is further operative to:
analyze egress patterns of the at least one viewer based on: i) an identity of the display screen, ii) a genre of the content displayed on the display screen, and iii) a time of the content being displayed on the display screen to historical patterns.

24. The system as in claim 14, wherein the image analyzer hardware is further operative to:
compare historical patterns for a viewer to other subscribers and to their personal historical viewing of the display screen.

25. The system as in claim 14, wherein the image analyzer hardware is further operative to:
via analysis of the blurred images and monitored motion, determine a probability that a viewer of the display screen will discontinue viewing the display screen during display of a particular advertisement on the display screen.

26. The system as in claim 14, wherein the image analyzer hardware is further operative to:
select an advertisement display on the display screen based on the stored viewer data indicating the reaction of the at least one viewer viewing the content previously displayed on the display screen.

27. Computer-readable storage hardware having instructions stored thereon, the instructions, when carried out by computer processor hardware, cause the computer processor hardware to:
receive blurred images of at least one viewer viewing a display screen, the blurred images protecting privacy of the at least one viewer;
monitor motion of the at least one viewer in the blurred images; and
based on the monitored motion, store data indicating a reaction of the at least one viewer viewing the content displayed on the display screen.
